(19) United States
(12) Patent Application Publication
(10) Pub. No.: US 2012/0226979 A1
(43) Pub. Date: Sep. 6, 2012

(54) Navigation of a Graphical User Interface Using Multi-Dimensional Menus and Modes

(75) Inventors: Maike Harberts, Koln (DE); Steffen Skopp, Dusseldorf (DE)

(73) Assignee: Leica Camera AG, Solms (DE)

(21) Appl. No.: 13/041,054

(22) Filed: Mar. 4, 2011

(51) Int. Cl. G06F 3/041; G06F 3/048

(52) U.S. Cl. 715/702

(57) ABSTRACT

A graphical user interface for display on a touchscreen display of an electronic user device includes operating modes arranged along at least a two dimensional plane of the graphical user interface, where the operating modes include at least a media play mode and a media capture mode. The graphical user interface also includes a currently-active view of a first operating mode displayed on the touchscreen display, where the currently-active view is changeable from the first operating mode to a second operating mode in response to a user input. Additionally, the graphical user interface includes a graphical representation of the second operating mode which is displayed on the touchscreen display as the currently-active view following the user input, where the user input corresponds to an instruction to navigate in a direction of the at least two dimensional plane of the graphical user interface which corresponds to the second operating mode.

### FIELD OF THE INVENTION

The present invention relates generally to a graphical user interface for use in connection with electronic user devices, and more particularly to a method for navigation of a graphical user interface using multi-dimensional menus and modes.

### BACKGROUND OF THE INVENTION

Electronic user devices, such as personal digital assistants (PDAs), cellular telephones, digital cameras, smartphones, etc., are continually evolving and being used to access an ever-increasing array of services and content. With this additional functionality, however, comes a need for an increasingly complex graphical user interface and menu system. The graphical user interface and menu system for such electronic user devices is essentially the gateway through which users are able to access available content, features and functions.

Traditional electronic user device menu systems involve a complex tree-like structure of menus and sub-menus corresponding to the various available features and content. As a result, locating the proper sub-menu for a desired feature can be a laborious and frustrating trial-and-error endeavor for the user. As a consequence, the traditional antiquated menu systems for modern electronic user devices are essentially becoming bottlenecks to adding additional functionality to such devices.

Accordingly, there is a need for an improved graphical user interface and method of navigating the same menu using multi-dimensional menus and modes.

### SUMMARY OF THE INVENTION

Disclosed and claimed herein are methods and electronic user devices for implementing a graphical user interface that is configured to be navigated using multi-dimensional menus and modes. In one embodiment, a method includes arranging operating modes along at least a two dimensional plane of the graphical user interface, where the operating modes include at least a media play mode and a media capture mode. The method also includes displaying, on the touchscreen display of the electronic user device, a currently-active view of a first operating mode and receiving a user input, to the touchscreen display, to change the currently-active view from the first operating mode to a second operating mode. The method further includes navigating, in response to the user input, in a desired direction of the at least two dimensional plane of the graphical user interface, corresponding to the second operating mode, and then displaying, as the currently-active view on the touchscreen display, a graphical representation of the second operating mode.

Additionally, disclosed and claimed herein is a graphical user interface of an electronic user device with a touchscreen display. The graphical user interface includes a plurality of operating modes arranged along at least a two dimensional plane of the graphical user interface, where the operating modes include at least a media play mode and a media capture mode. The graphical user interface also includes a currently-active view of a first operating mode displayed on the touchscreen display of the electronic user device, where the currently-active view is changeable from the first operating mode to a second operating mode in response to a user input. Additionally, the graphical user interface includes a graphical representation of the second operating mode which is displayed on the touchscreen display as the currently-active view following the user input, where the user input corresponds to an instruction to navigate in a direction of the at least two dimensional plane of the graphical user interface which corresponds to the second operating mode.

Other aspects, features, and techniques of the invention will be apparent to one skilled in the relevant art in view of the following description of the exemplary embodiments of the invention.

### BRIEF DESCRIPTION OF THE DRAWINGS

FIG. 1 illustrates a simplified schematic of an electronic user device configured to implement one or more embodiments of the invention;

FIG. 2 is a graphical representation of how a graphical user interface may be navigated using multi-dimensional menus and modes, in accordance with the principles of the invention;

FIGS. 3A-3C are screenshots taken from an electronic user device, such as the electronic user device of FIG. 1, depicting various aspects of a graphical user interface configured in accordance with the principles of the invention;

FIGS. 4A-4C are screenshots taken from an electronic user device, such as the electronic user device of FIG. 1, depicting content navigation features of a graphical user interface configured in accordance with the principles of the invention;

FIGS. 5A-5D are various additional screenshots taken from an electronic user device, such as the electronic user device of FIG. 1, depicting additional content selection and navigation functionality of a graphical user interface configured in accordance with the principles of the invention;

FIGS. 6A-6D are various additional screenshots taken from an electronic user device, such as the electronic user device of FIG. 1, depicting various menu navigation functionalities and features of a graphical user interface configured in accordance with the principles of the invention;

FIG. 7 is a state diagram illustrating the relationship between multi-dimensional menus and modes for implementation using a graphical user interface configured in accordance with the principles of the invention;

FIGS. 8A-8C are various additional screenshots taken from an electronic user device, such as the electronic user device of FIG. 1, depicting additional content selection and navigation functionalities of a graphical user interface configured in accordance with the principles of the invention;

FIG. 9 is another example of the block diagram of FIG. 7, illustrating the relationship between multi-dimensional menus and modes for implementation using a graphical user interface configured in accordance with the principles of the invention;

FIGS. 10A-10D are various additional screenshots taken from an electronic user device, such as the electronic user device of FIG. 1, depicting additional content selection and navigation functionalities of a graphical user interface configured in accordance with the principles of the invention; and

FIGS. 11A-11D are various additional screenshots taken from an electronic user device, such as the electronic user device of FIG. 1, depicting additional content selection and navigation functionalities of a graphical user interface configured in accordance with the principles of the invention.

### DETAILED DESCRIPTION OF THE EXEMPLARY EMBODIMENTS

The present disclosure relates generally to a method, electronic device and graphical user interface for implementing multi-dimensional menus and modes on a touchscreen display of electronic user devices.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation. The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

In the following detailed description, numerous specific details are set forth in order to provide a thorough understanding of the present invention. However, it should be appreciated that the invention may be practiced without such specific details. Additionally, for brevity sake well-known methods, procedures, components, and circuits have not been described in detail.

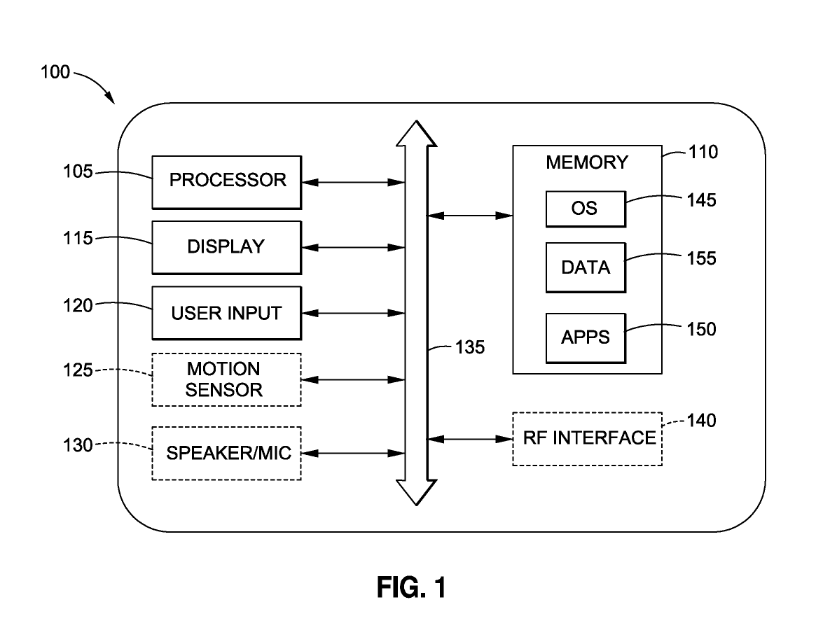

With reference now to FIG. 1, depicted is one embodiment of an electronic user device 100 capable of implementing one or more aspects of the invention. The electronic user device 100 may be a cellular telephone, smartphone, PDA, digital camera, handheld computer, etc.

As shown in FIG. 1, the exemplary electronic user device 100 includes a processor 105, a memory 110, a touchscreen display 115 and a user input 120, each being interconnected by bus 135. The electronic user device 100 may also include additional optional components, such as an optional motion sensor 125, optional speaker/microphone 130 and/or an optional radio frequency interface 140 that performs the function of transmitting and receiving radio frequency signals from one or more wireless networks. It should be appreciated that the processor 105 may be a general processor, a digital signal processor, an application-specific integrated circuit, digital logic device, an analog processor or other now known processing circuit.

With respect to the user input 120, it may be implemented using a keypad, such as a push-button dialing pad, a keyboard or the like. The touchscreen display 115 may be an LCD or any other type of display commonly used in consumer electronic devices. Since the display 115 is preferably touch-sensitive, it may serve the dual function of being a display screen as well as part of the user input 120. The optional motion sensor 125 may be comprised of any known motion sensing technology, such as a three-dimensional acceleration and/or velocity sensor technology, two-dimensional acceleration and/or velocity sensor technology, a strain or tilt detector, or any other sensor capable of detecting movement of the handheld device 100 by its user.

Memory 110 may include random access memory and/or non-volatile memory, such as one or more magnetic disk storage devices, one or more optical storage devices and/or flash memory. As shown, stored in memory 110 is at least one operating system 145, which comprises procedures (or sets of instructions) for handling basic system services and for performing hardware dependent tasks. One or more applications 150 and data 155 may also be stored in memory.

It should further be appreciated that the memory 110 may include computer instructions, as part of the operating system 145 and/or an application 150, that determine one or more points of contact, direction of movement and/or speed of movement along the device's touchscreen display 115.

Although not necessarily pertinent to the scope of the disclosure, it should be appreciated that the applications 150 may comprise one or more of a web browser, chat interface application, a camera application, a phone dialer program, email client, word processing application, etc.

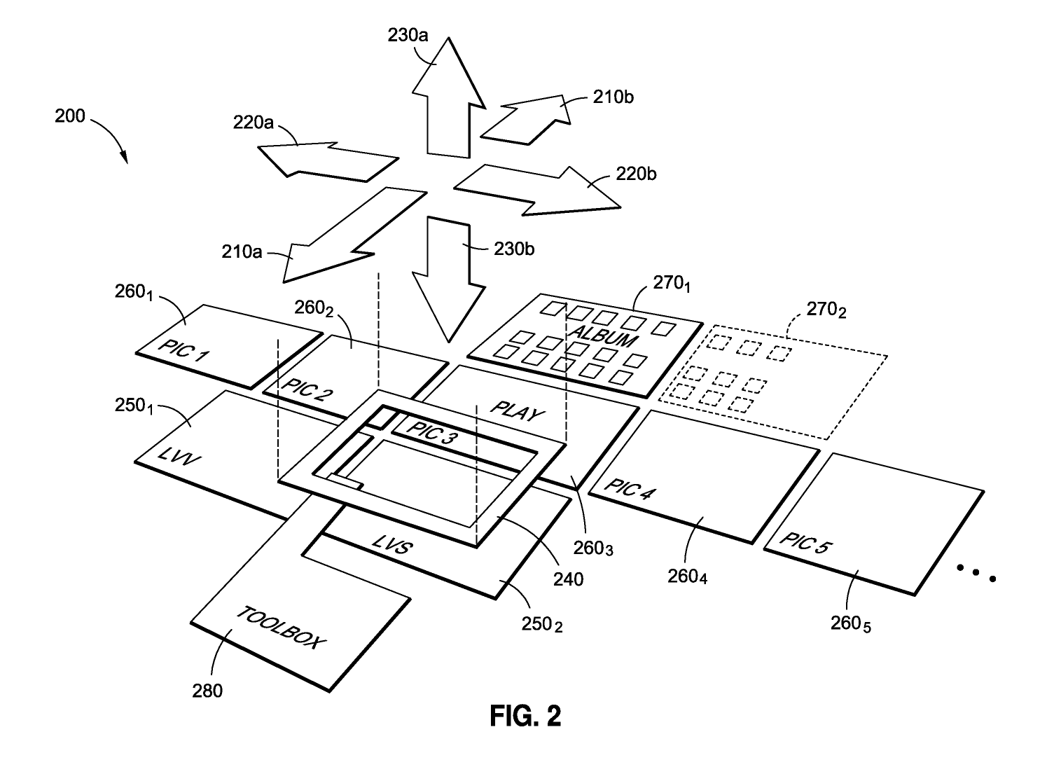

Referring now to FIG. 2, depicted is a three dimensional graphical representation 200 of how a graphical user interface may be navigated using multi-dimensional menus and modes, in accordance with the principles of the invention. User navigation of the interface's various menus and modes may proceed in a three dimensional fashion, as shown by the collective navigational directions 210a, 210b, 220a, 220b, 230a and 230b. In particular, navigational directions 210a and 210b combine to provide navigational functionality of the graphical user interface in one dimension or plane, while the combination of navigational directions 220a and 220b provide navigational functionality in a second dimension. Finally, navigating along directions 230a and 230b would provide the user with navigational functionality in still a third dimension or plane.

Continuing to refer with FIG. 2, frame 240 is representative of the currently-active view for a graphical user interface, configured in accordance with the principles of the invention, as it is being displayed on a touch-sensitive screen (e.g., display 115) by an electronic user device (e.g., electronic user device 100). In the current state of FIG. 2, the active view is of the ‘Live View Still’ (LVS) mode 250₂, which corresponds to a mode of operation, for the electronic user device, in which still photos are captured. Adjacent to the LVS mode 250₂ is the ‘Live View Video’ (LVV) mode 250₁, which corresponds to a mode of operation in which the user device may capture video. While only two media capture modes are included in the representation 200 of FIG. 2, it should be appreciated that additional media capture modes may be similarly included. Moreover, the term ‘view’ and ‘mode’ may be used interchangeably herein.

As will be described in more detail below, to activate the device's LVV mode 250₁ while the current mode is LVS mode 250₂, as is the case in FIG. 2, a user may access the device's LVV mode 250₁ utilizing the device's touch-sensitive display by navigating the currently-active view. For example, the user may touch/contact a portion of frame 240 (i.e., containing the currently-active view) using one or more fingers and, while still in contact therewith, apply a swiping or dragging motion in direction 220b (i.e. swiping to the right in FIG. 2), By applying this dragging or swiping motion in direction 220b, the view associated with LVS mode 250₂ will be ‘dragged’ or moved out of frame 240 in the same direction 220b as the dragging, while at the same time causing the adjacently-located LVV mode 250₁ to occupy frame 240 and therefore become the currently-active view (which in this case is an operational mode). In fact, either the LVV mode 250₁ or the LVS mode 250₂ may be readily accessed by applying a swiping or dragging motion along the touch-sensitive display in the navigational directions of 220a or 220b.

In accordance with the above-described dragging or swiping motion, it may be the case that navigating in a particular direction (e.g., direction 220a) means that the user is applying a dragging motion in the opposite direction (e.g., direction 220b). That is, in order to access desired content, functions or modes that are located away from the currently-active view off in a particular direction, it is necessary to effectively ‘drag’ such content towards the frame 240 by applying the dragging motion in the opposite direction (e.g., content/modes located above the frame 240 are accessed by dragging down, content/modes located to the left of the frame 240 are accessed by dragging to the right, etc.). Similarly, it should be appreciated that such navigation may be performed in any direction on a continuous or looping manner such that continued navigation in a particular direction will result in the variously available views cycling around and into the currently-active view (i.e., frame 240), regardless of the direction in which the navigation is occurring. By way of a simple example, and with continuing to refer to FIG. 2, a dragging motion may be applied in either direction 220a or 220b to access the LVV mode 250₁ since a dragging motion in direction 220b (i.e., swiping to the right) would cause the adjacently-located LVV mode 250₁ to immediately enter frame 240, while a continuing dragging motion in direction 220a (i.e., swiping to the left) would cause the views to cycle around until the LVV mode 250₁ becomes the currently-active view in frame 240. It should further be appreciated that this continuous or looping effect may occur regardless of the number of available modes or views in any given direction.

Continuing to refer to FIG. 2, rather than navigating in direction 220a, as described above, a user may similarly navigate in directions 210a and 210b so as to enter the ‘play’ mode. Moreover, another aspect of navigating to the play mode may be to cause a particular media file to occupy frame 240 and therefore become the currently-active view. In the embodiment of FIG. 2, this media file is ‘pic 3’, shown as media file 260₃. The particular media file that becomes the first to be displayed in frame 240 when navigating in direction 210b may be based on what the last-viewed media file was during the last access of the device's ‘play’ mode. However, any number of other characteristics may be used to determine which media file is the first to be displayed, e.g., date of creation, alphabetically, etc.

Regardless of which media file is the first to be displayed in frame 240 when a user navigates to the device's play mode, all of the media files 260₁-260₅ (and beyond) may be easily accessed by applying a swiping or dragging motion along the touch-sensitive display in the navigational directions of 220a and 220b. Although not shown in FIG. 2 for clarity, it should be appreciated that the number of media files available to be navigated along directions 220a and 220b may be limited only by the capacity of the device's memory (e.g., memory 110) to store such files. Additionally, while media files 260₁-260₅ are shown as being digital still photos in the representation 200, it should be appreciated that they may similarly comprise one or more digital video files and/or digital music files.

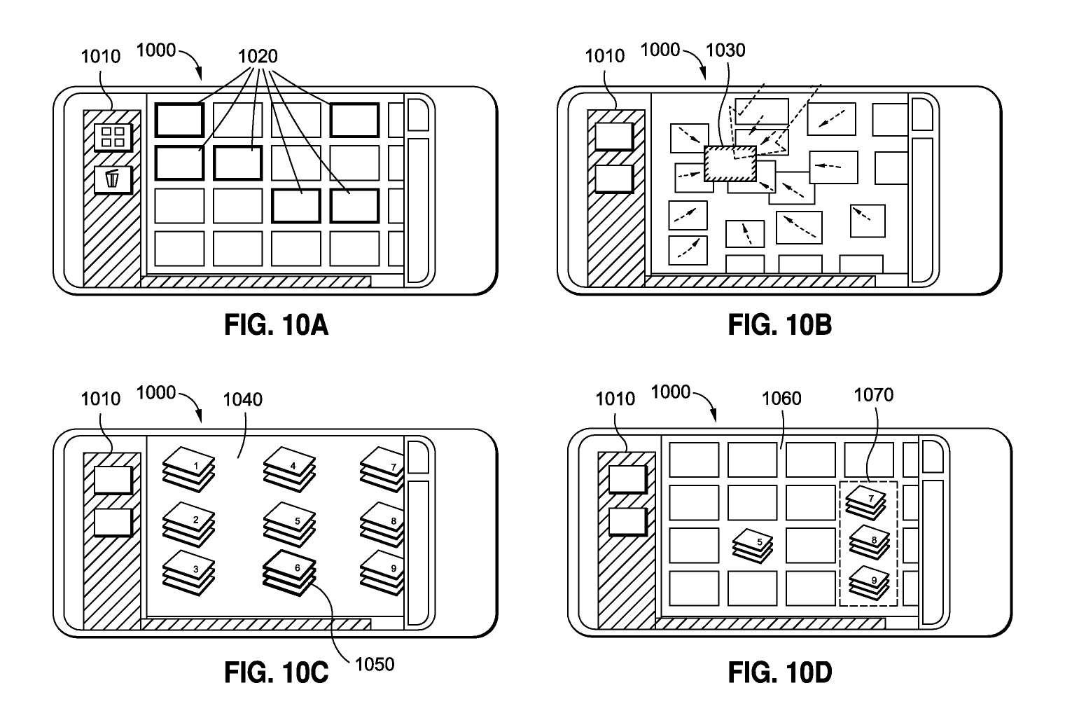

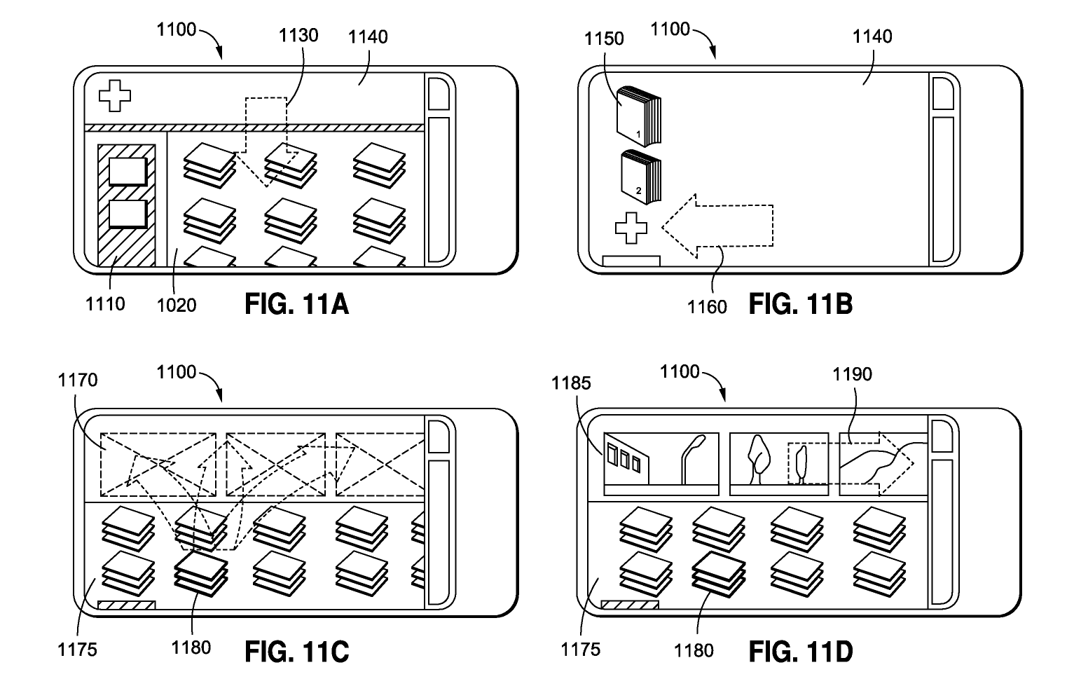

Continuing to navigate the graphical user interface in the 210b direction from the play mode will cause the album view to be accessed and displayed in frame 240 of the device's touch-sensitive display. While in album view, a plurality of media albums 270₁ and 270₂ may be accessed by navigating in directions 220a and 220b. Albums may be user-defined collections of media file, organized or collected together according to type, date, event, location, etc. While FIG. 2 depicts only two available albums 270₁ and 270₂, the number of available albums that may be accessed from the album view may be limited only by the capacity of the device's memory (e.g., memory 110). Additionally, it should be appreciated that albums 270₁ and 270₂ may each contain digital music files, digital still photos, digital video files, or any combination thereof. The creation and navigation of albums will be described in more detail below with reference to FIGS. 10A-10D and further with respect to FIGS. 11A-11D.

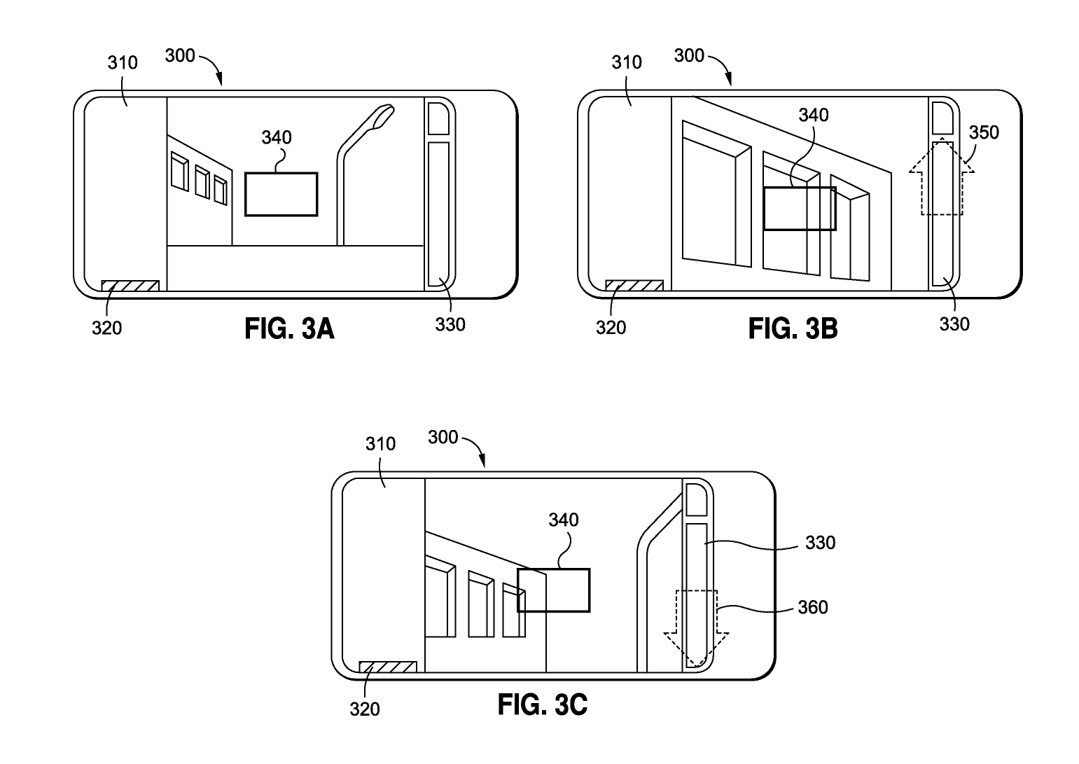

As shown in FIG. 2, the graphical user interface also provides the user with the ability to navigate in directions 230a and 230b. In one embodiment, navigation in directions 230a and 230b may be associated with a zoom function, whereby any of the album view, play mode and/or capture modes LVV and LVS may be zoomed into (direction 230b) or zoomed away from (direction 230a). In certain embodiments, a touch-sensitive slider-type or trackball-type device (not shown) on the user device may be used to invoke the zoom function. A more detailed description of navigating the graphical user interface in directions 230a and 230b (i.e., zooming in and out) is provided below with reference to FIGS. 3A-3C.

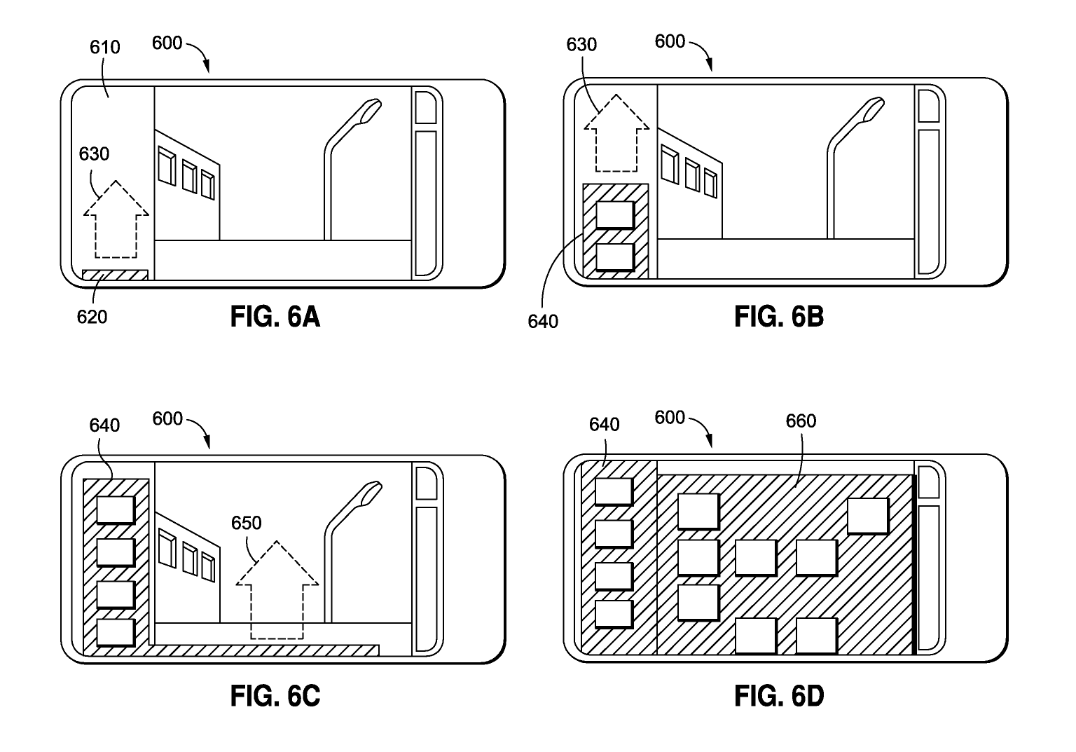

Still another aspect of the graphical user interface of the present invention is the ability to access a toolbox 280 for display by the electronic user device. Again, using the above-described swiping or dragging motion, a user may drag the toolbox (or a portion thereof) into frame 240. The toolbox 280 may contain one or more selectable icons in a side bar configuration from which a further extended menu may be accessed, as described in detail below with reference to FIGS. 6A-6D. In either or both of the side bar and extended menu, the icons may be static or mode/context specific, and may be selected by the user touching the displayed icon on the device's touch-sensitive screen. In one or more embodiments, such an extended menu of the toolbox 280 may be implemented using a graphical orbital menu, such as the orbital menu disclosed and claimed in co-pending patent application Ser. No. 13/040,796, which is entitled “Graphical User Interface Having An Orbital Menu System”, filed on even date herewith and hereby fully incorporated by reference (hereinafter, the “Orbital Menu Patent Application”).

In any event, the side bar and extended menu that comprise the toolbox 280 may be accessibly from any screen, and may be ‘pulled up’ by touching and dragging a ‘toolbox corner’ from a hidden view up into the currently-active view of frame 240. A more detailed description of the toolbox 280 is provided below with reference to FIGS. 6A-6D.

For clarity, the representation 200 of FIG. 2 has been simplified in some respects. For example, the frame 240 does not necessarily have to be on media file 260₃ in order for the user to be able to navigate down to LVS mode 250₂ in direction 210a or up to the album view in direction 210b. That is, if the currently-active view is play mode, regardless of the media file being viewed in frame 240 (e.g., media file 260₅), navigating in the direction 210a may cause the device to enter one of the operational modes of LVV mode 250₁ or the LVS mode 250₂. Similarly, if the device is in album mode, regardless of which album 270₁ or 270₂ is being viewed in frame 240, navigating in the direction 210a will cause the device to enter the play mode and display one or more of the stored media files.

In sum, using the above-described navigational concepts, all functions, features and options relating to the device's imaging functionality may be accessed without the use of traditional menus.

It should of course be appreciated that the various modes, menus, features and functions, including their positional relationship to each other, which are shown in the representation 200 of FIG. 2, are intended to be non-limiting and exemplary only. Numerous variations thereof are within the scope of this disclosure and would be consistent with the principles of the invention.

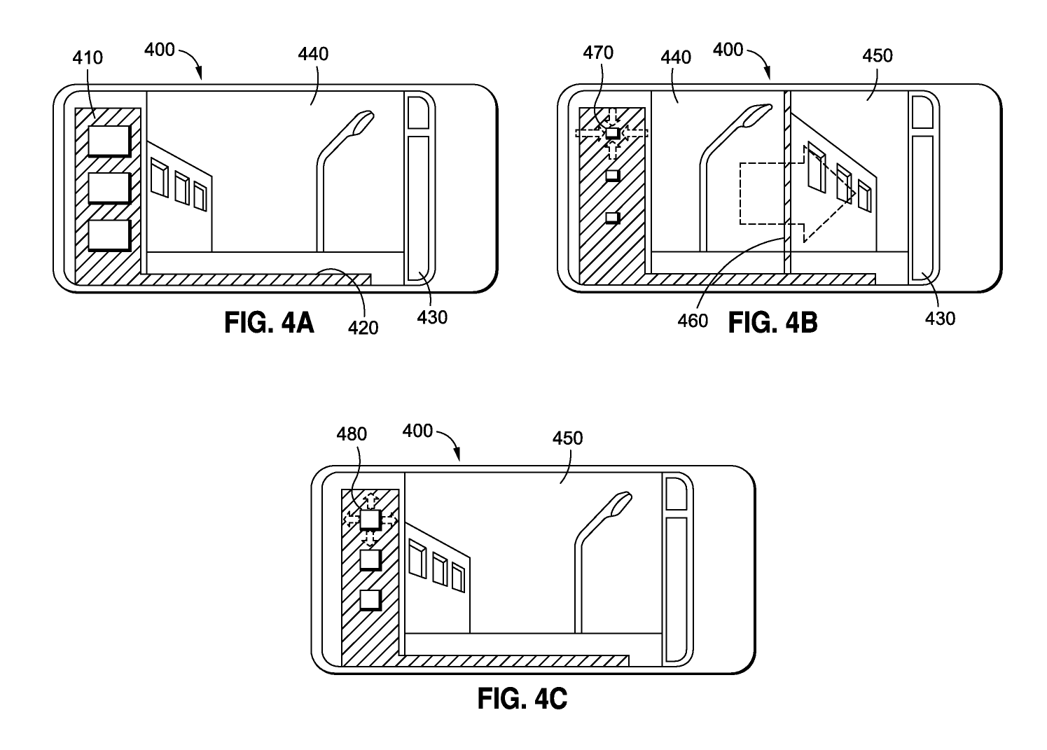

With reference now to FIGS. 3A-3C, depict various screenshots of the graphical user interface, configured in accordance with the principles of the invention, being displayed by an electronic user device, such as electronic user device 100 of FIG. 1. Specifically, in FIG. 3A the graphical user interface 300 comprises a side bar area 310, a side bar tab 320 and a slider-type device 330. In certain embodiments, a plurality of icons (not shown) corresponding to various functions may be accessible by the user dragging the side bar tab 320 up so as to fill at least a portion of the side bar area 310. This dragging may be accomplished using the same dragging motion described above whereby the user contacts the touch-sensitive screen using one or more fingers and slides the point of contact in the desired direction, which in this case is up. The side bar tab 320 may be the ‘toolbox corner’ referenced above with reference to FIG. 2. Additional aspects of this feature are described below with reference to FIGS. 4A-4C.

The slider-type device 330 may be used to perform a zoom function for the currently-displayed media. This function may correspond to the navigational directions 230a and 230b, as described above with reference to FIG. 2. The slider-type device 330 may be implemented either separate from or integral with the device's touch-sensitive display. In either case, the device's zoom function may be invoked when the user slides one or more fingers up or down the slider-type device 330 (or the area filled by the slider-type device 330 on the touch-sensitive display), as shown in FIGS. 3B and 3C. For example, the user may use the slider-type device 330 to zoom in closer to the currently-displayed media by dragging the slider-type device 330 in direction 350, as shown in FIG. 3B. Conversely, the user may use the slider-type device 330 to zoom out away from the currently-displayed media by dragging the slider-type device 330 in direction 360, as shown in FIG. 3C. The zoom function of slider-type device 330 may be used in either a media play mode in which previously-captured media is displayed, or in a media capture mode in which the device's camera zoom level may be adjusted. While not shown in the figures, it should also be appreciated that the slider-type device 330 may be implemented using a trackball-type mechanism, or individual contact points that are sensitive to touch and direction of motion.

Additionally, a zoom area indicator 340 may be used to define the portion of the currently-displayed media (when in play mode) or the image to be captured (when in media capture mode) about which the zooming effect will occur, e.g., the focus or center of the zoom. The zoom area indicator 340 may be displayed when the user first contacts the slider-type device 330.

Additionally, when in a media play mode, the indicator 340 may be user-adjustable so as to provide the user with the ability to drag or move the zooms focus or center around the currently-displayed media, such that a specific user-selected portion of the media becomes the center or focus of any subsequently applied zooming.

While the side bar area 310 is shown as an overlay that obstructs the currently-displayed media in FIGS. 3A-3C, it should also be appreciated that the currently-displayed image need not be overlaid or obstructed until the user pulls up the actual side bar, e.g., by dragging up the side bar tab 320.

Referring now to FIGS. 4A-4C, depict various screenshots of the graphical user interface 400 having a side bar 410 having a plurality of icons, and being displayed by an electronic user device, such as electronic user device 100 of FIG. 1. The side bar 410 may have been accessed using a side bar tab 320, as described above with reference to FIGS. 3A-3C. The side bar 410 may further include an icon for accessing an expanded menu that is in the form of the orbital menu disclosed and claimed in the previously-referenced co-pending Orbital Menu Patent Application. Alternatively, an expanded menu tab 420 that is displayed after the side bar 410 is displayed may be usable to access an expanded menu, such as the expanded menu described in more detail below with reference to FIGS. 6A-6D.

Continuing to refer to FIG. 4A, one or more of the icons in the side bar may be fixed or constant across different views, or alternatively be context-specific such that the functions and options accessible from the side bar 410 correspond to the currently-active view 440. For example, the currently-active view 440 for FIG. 4A is LVS mode 250₂ which, as described above with reference to FIG. 2, corresponds to a mode of operation in which still photos may be captured. Thus, the functions and options that are accessible from the side bar 410 may correspond to the options and functions corresponding to the live viewing of still photos (e.g., picture format, picture resolution, flash, review, erase, etc.). In contrast, where one or more of the side bar 410 icons are static, such switching to a different mode of operation may not result in any change in the icons. In this fashion, a user may be able to access a ‘favorites’ menu, an expanded menu, etc., regardless of which operating mode has been selected.

Referring now to FIG. 4B, depicted is an illustration of the graphical user interface 400 as it transitions the currently-active view 440 to a newly-active view 450. In certain embodiments, this transition is performed by the user navigating in a direction corresponding to the newly-active view 450. For example, where the currently-active view 440 is LVS mode 250₂ and the newly-active view 450 is LVV mode 250₁, the transition may be performed by the user navigating the interface in direction 220a or, in the case of a continuously-looping navigation, in direction 220b as described above with reference to FIG. 2. As also detailed above, a user may quickly and easily navigate between such operational modes by swiping or dragging along the touch-sensitive display and without the need to access menus or submenus. Similar, the user may toggle back and forth between modes of operation by panning back and forth along the particular navigational directions using the device's touch-sensitive display.

As the newly-active view 450 is dragged into the graphical user interface 400, and the currently-active view 440 dragged out of view, a transition line 460 that graphically divides such views may be used to demarcate the progress of the transition as it occurs. Alternatively, rather than graphically representing the transition using the transition line 460, such transition progress may be graphically shown using gradually disappearing/appearing icons (not shown) corresponding to the currently-active and newly-active views, respectively.

While at least some of the icons in the side bar may be static, in the event that some of the icons in the side bar are alternatively context-specific, it may be an additional feature of the invention that the icons undergo a corresponding transition from icons that invoke functions and options specific to the currently-active view 440 to icons that invoke functions and options specific to the newly-active view 450. One example of such icon transition is shown in FIGS. 4B and 4C. As a view transition begins, the icons in side bar, corresponding to the currently-active view 440, begin to shrink and disappear, as shown by graphical elements 470 of FIG. 4B. Thereafter, as the view transition approaches completion, for those icons that are context-specific, a new set of icons that invoke functions and options associated with the newly-active view 450 may be graphically represented as expanding or appearing and hence re-filling the side bar, as shown by graphical elements 480 of FIG. 4C. Of course, in the case where the icons are static and not context specific, no such icon transition would be needed. It should of course be appreciated that the icon transition that accompanies a view or mode transition may be graphically represented in numerous way and be consistent with the principles of the invention.

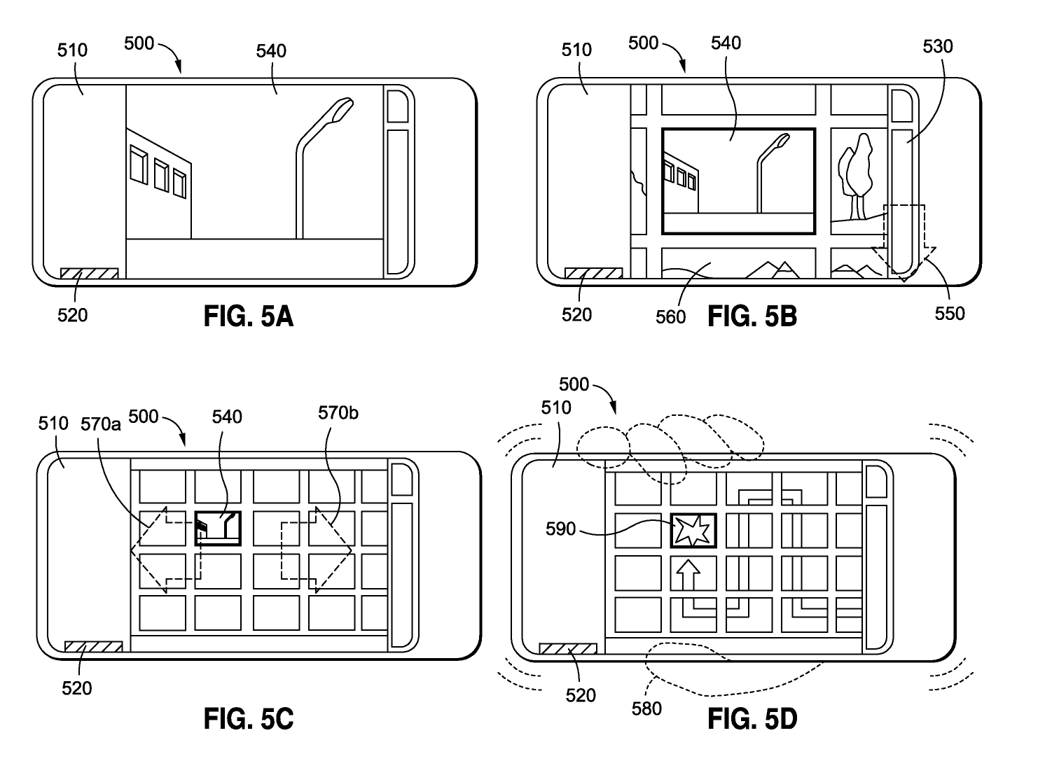

Referring now to FIGS. 5A-5D, depicted are various additional screenshots taken from an electronic user device, such as the electronic user device 100 of FIG. 1, depicting additional content selection and navigation functionality of a graphical user interface configured in accordance with the principles of the invention. In particular, FIGS. 5A-5D depict various functions and options that may be available to a user while the device and the graphical user interface 500 are in a media play mode. In particular, the graphical user interface 500 includes an empty side bar area 510, a user-selectable side bar tab 520. Additionally, a slider-type device 530 (see FIG. 5B) may be integral with or separate from the touch-sensitive display). As previously described, the slider functionality may similarly be implementing using a trackball-type mechanism, or individual contact points that are sensitive to touch and direction of motion. In any event, the functionality of these elements 510-530 may be the same as the corresponding elements 310-330 described above with reference to FIGS. 3A-3C, and as such will not be repeated here. Since the device is in the media play mode, the currently-selected media 540 may be displayed, as shown in FIG. 5A.

FIG. 5B illustrates one example of the zoom function, invoked by dragging or swiping slider-type device 530 in direction 550. In this example, the zoom function corresponds to zooming out from the currently-selected media 540, which correspondingly causes other available media 560 to come into view, as shown in FIG. 5B.

FIG. 5C depicts a state of the graphical user interface 500 after the user has continued to zoom out, while still in play mode, thereby causing a widen view of the other available media 560. As originally described above with reference to media files 260₁-260₅ of FIG. 2, the graphical user interface 500 may be further configured to allow the user to navigate other available media 560 by applying a dragging motion to the touch-sensitive screen in directions 570a and 570b, for example. The graphical user interface 500 may be configured to allow the user to navigate in other directions (e.g., up and down) while in play mode.

FIG. 5D graphically illustrates how a user 580 may apply a pre-defined motion (e.g., ‘shaking’ motion) that is detectable by the device's motion sensor (e.g., motion sensor 125) in order to delete the currently-selected media, shown graphically as element 590 in FIG. 5D, without having to access any icon or menu. FIG. 5D also illustrates how, as or after the currently-selected media is deleted, the graphical user interface 500 may show the other media files moving up in line beneath the deleted file so as maintain the contiguousness of the other available media files.

Referring now to FIGS. 6A-6D, depicting are various menu navigation functionalities and features of a graphical user interface 600 configured in accordance with the principles of the invention. In particular, FIG. 6A depicts the graphical user interface 600 as including a side bar area 610 and side bar tab 620, as first described above with reference to FIGS. 3A-3C. In certain embodiments, this arrangement may be used to selectively display a plurality of user-selectable corresponding to various functions. In the examples provided herein, such icons may be accessible by the user dragging the side bar tab 620 up in direction 630 so as to fill at least a portion of the side bar area 610. This dragging may be accomplished using the same dragging motion described above whereby the user contacts the touch-sensitive screen using one or more fingers and slides the point of contact in the desired direction, which in this case is up.

FIG. 6B depicts the graphical user interface 600 while the user is in the process of pulling up the side bar 640 by applying a pulling or dragging motion across the device's touch-sensitive screen in direction 630.

FIG. 6C then depicts the graphical user interface 600 after the side bar 640 is in place, including the plurality of icons comprising the side bar 640. As mentioned below, the icons comprising the side bar 640 may be mode or context-specific. FIG. 6C further depicts an expanded menu tab 650, which may be displayed only after the side bar 640 has been accessed, and may be further usable to pull up an expanded menu, such as expanded menu 660, by applying an additional pulling or dragging motion across the device's touch-sensitive screen along direction 650.

As described above, it should be appreciated that the aforementioned expanded menu may be implemented by an orbital menu system, as disclosed and claimed in the previously-referenced “Orbital Menu Patent Application.” Alternatively, the aforementioned expanded menu may be implemented as expanded menu 660, as shown in FIG. 6D. Moreover, just as with the side bar 640, the additional features and options accessible from the expanded menu (e.g., orbital menu or menu 660) may either be static or context-specific. In either case, a set of more frequently accessed options and features may be accessible by pulling up a convenient side bar, while less frequently accessed options and features may be subsequently easily accessed from the expanded menu. In this fashion, a wide range of features and options are available to a user without the need for a complex menu and submenu architecture

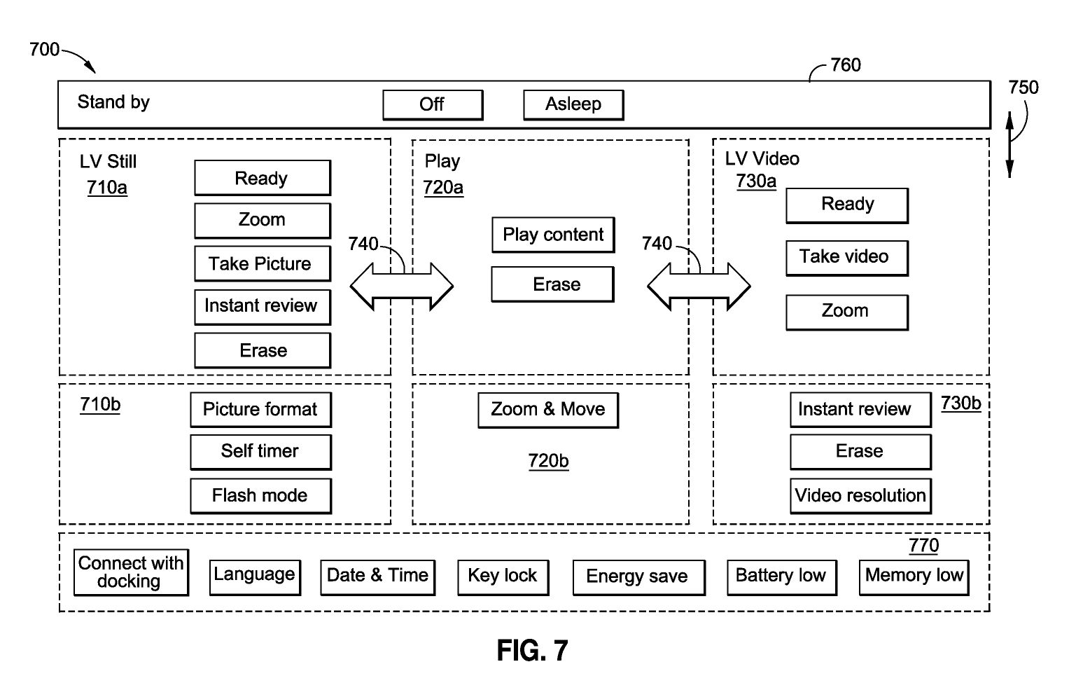

FIG. 7 is a state diagram illustrating the relationship between multi-dimensional menus and modes for implementation using a graphical user interface configured in accordance with the principles of the invention. Specifically, diagram 700 illustrates how a user can navigate from mode to mode or state to state using the graphical user interface disclosed and claimed herein. For example, state 710a corresponds to a ‘Live View Still’ (LVS) mode (e.g., LVS mode 250₂), state 720a corresponds to the play mode, and state 730a corresponds to a ‘Live View Video’ mode (e.g., LVV mode 250₁), as each is described in detail above with reference to FIG. 2.

While the graphical user interface is in state 710a, various imaging functions and options are available to the user without the need to access any menus or submenus by, for example, interacting with a touch-sensitive screen of the device implementing the graphical user interface. Additionally, state 710b may be selectively accessed by pulling up a side bar using a side bar tab as described above, including the description above of FIGS. 6A-6D. From state 710b, the user may select an additional level or set of state-specific or static features and options, such as from the aforementioned side bar.

As also described above with reference to FIG. 2, another aspect of the invention is to provide a graphical user interface which a user may navigate in a multidimensional manner. Specifically, a user may navigate between states 710a, 720a and 730a by navigating the graphical user interface in one or more directions, shown as state transitions 740 in FIG. 7. To do so, the user may touch/contact a portion of the currently-active view using one or more fingers and, while still in contact therewith, apply a swiping or dragging motion so as to cause an adjacent view or mode to be dragged into the graphical user interface's current view, as previously described above with reference to FIG. 2.

Continuing to refer to FIG. 7, each of states 710a, 720a and 730a comprise context-specific and/or static functions that are accessible to the user without the need to access any menus. Additionally, a corresponding set of states 710b, 720b and 730b are additionally accessible from states 710a, 720a and 730a, respectively, such as by pulling up a side bar using a side bar tab, as described above for example. From these additional states 710b, 720b and 730b, the user may select from among additional context-specific and/or static features and options. It should of course be appreciated that the specific features and options depicted in FIG. 7 are provided by way of example only, and are not intended to be limiting nor exhaustive.

Regardless of the current mode or state of the graphical user interface, there may similarly be some additional set of functions and options that are user accessible by either navigating in a predetermined direction, or applying a predetermined input to the touch-sensitive screen of the device implementing the graphical user interface. For example, standby state 760 may be accessible by the user after the occurrence of state transition 750, which may be invoked using a hard key or contacting the touch-sensitive display at a predetermined location or in a predetermined manner. Similarly, state 770 may be accessible from any current state, and may be used to access features and options which are generically applicable, rather than being context specific. In certain embodiments, state 770 may correspond to accessing an extended menu, such as the extended menu 660 described above with reference to FIG. 6D.

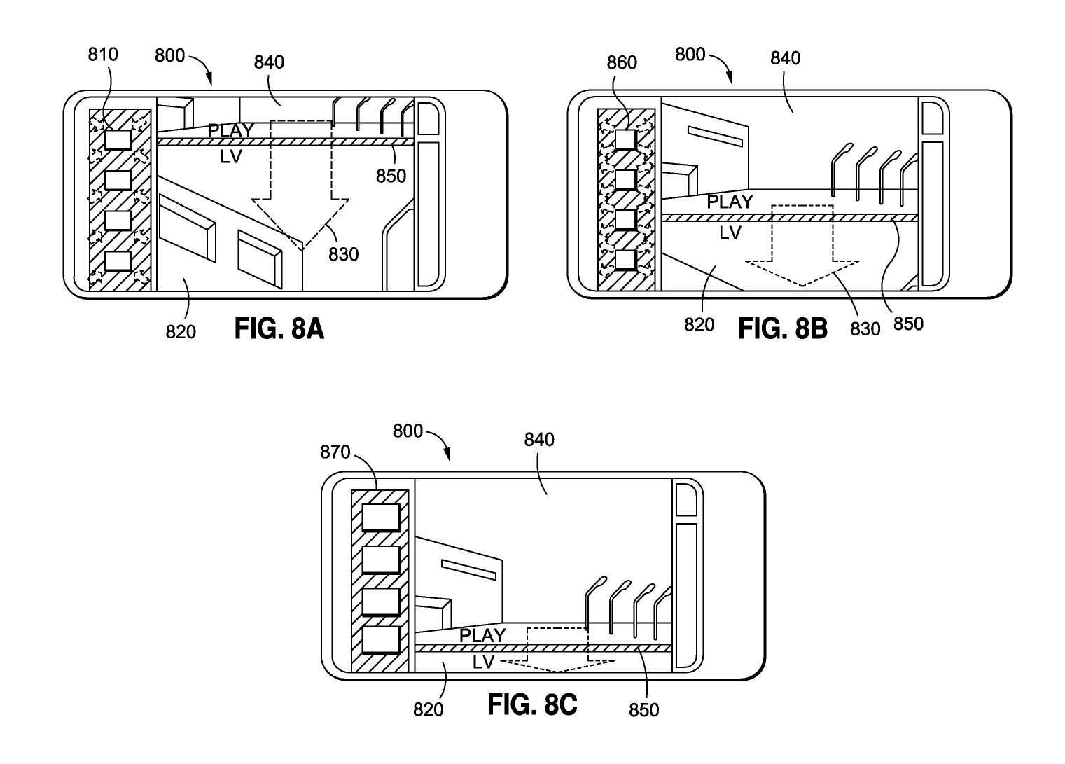

Referring now to FIGS. 8A-8C, depicted are various additional screenshots taken from an electronic user device, such as the electronic user device 100 of FIG. 1, depicting the graphical user interface 800 as a state transition is occurring from live view mode 820 (e.g., LVS or LVV mode) to a play mode 840. Referring first to FIG. 8A, the graphical user interface 800 includes a side bar 810 having a plurality of the icons that may be either static, or alternatively context-specific such that specific functions and options corresponding to the current currently-active mode, i.e., live view mode 820, may be readily selected. In certain embodiments, this transition may be performed by the user navigating in direction 830, which in the example of FIGS. 8A-8C, corresponds to the play mode 840. As detailed above, a user may quickly and easily navigate between such operational modes by swiping or dragging along the touch-sensitive display in a particular direction and without the need to access menus or submenus. Similar, the user may toggle back and forth between modes of operation by panning back and forth along the particular navigational directions using the device's touch-sensitive display.

As the desired play mode 840 is dragged into the graphical user interface 800, and the live view mode 820 dragged out of view, a transition line 850 that graphically divides such views may be used to demarcate the progress of the transition as it occurs. Alternatively, rather than graphically representing the transition using the transition line 850, such transition progress may be graphically shown using gradually disappearing/appearing icons (not shown) corresponding to the currently-active and newly-active views, respectively.

While at least some of the icons in the side bar 810 may be static, in the event that some of the icons in the side bar are alternatively context-specific, it may be an additional feature of the invention that at least some of the icons undergo a corresponding transition from icons that invoke functions and options specific to the live view mode 820 to icons that invoke functions and options specific to the desired play mode 840. One example of the accompanying icon transition is shown in FIGS. 8A-8C. Specifically, as the mode transition begins in FIG. 8A, the icons in side bar 810 that corresponding to the live view mode 820, begin to shrink and disappear. Thereafter, as the mode transition progresses further, as shown in FIG. 8B, a new set of icons that correspond to the functions and options associated with the play mode 840 may be graphically represented as expanding or appearing and hence re-filling side bar 860. Finally, as the mode transition is just about completed, as shown in FIG. 8C, the icon transition that accompanies the mode transition may also be completed such that the icons comprising side bar 870 now correspond to the new desired mode-play mode 840. It should of course be appreciated that the icon transition that accompanies a view or mode transition may be graphically represented in numerous way and be consistent with the principles of the invention.

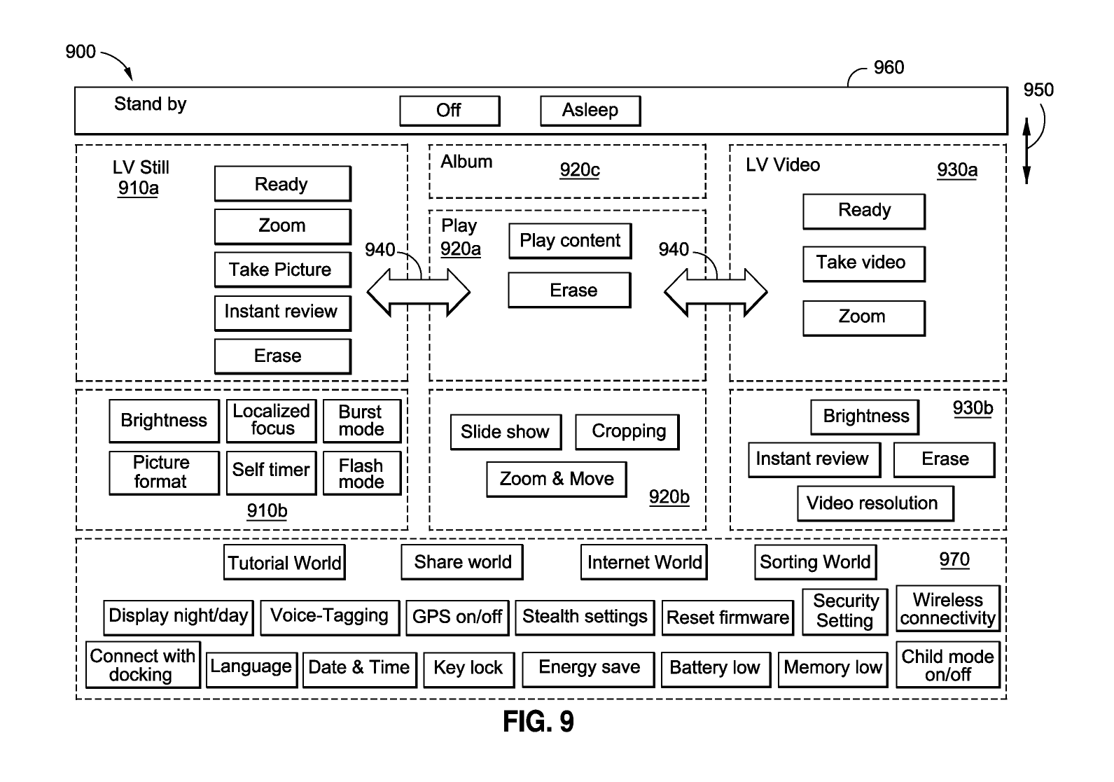

Referring now to FIG. 9, illustrated is a more detailed and alternative example to the state diagram of FIG. 7 above. Specifically, diagram 900 similarly illustrates how a user can navigate from mode to mode or state to state using the graphical user interface disclosed and claimed herein. In this example, state 910a corresponds to a ‘Live View Still’ (LVS) mode (e.g., LVS mode 250₂), state 920a corresponds to the play mode, state 930a corresponds to a ‘Live View Video’ mode (e.g., LVV mode 250₁), as each was described in detail above. Additionally, state 920c corresponds to the album view described above with reference to FIG. 2.

As shown, various context-specific functions and options are available to the user in each of the each of states 910a, 920a, 920c and 930a. Additionally, a corresponding set of states 910b, 920b and 930b may be additionally accessible from states 910a, 920a, 920c and 930a, respectively, such as by pulling up a side bar using a side bar tab, as described above for example. From these additional states 910b, 920b and 930b, the user may select from among additional context- or mode-specific features and options. It should of course be appreciated that the specific features and options depicted in FIG. 9 are provided by way of example only, and are not intended to be limiting nor exhaustive.

As was also described above with reference to FIG. 7, a user may navigate between states 910a, 920a, 920c and 930a by navigating the graphical user interface in one or more directions, depicted in FIG. 9 as state transitions 940 by, for example, contacting a portion of the currently-active view using one or more fingers and, while still in contact therewith, apply a swiping or dragging motion so as to cause an adjacent view or mode to be dragged into the graphical user interface's current view.

Continuing to refer to FIG. 9, the state diagram 900 further shows the availability of a standby state 960 that may be accessible to a user after the occurrence of state transition 950, which may be invoked using a hard key or contacting the touch-sensitive display at a predetermined location or in a predetermined manner. Moreover, as with state 770 of FIG. 7, state 970 may be accessible from any current state, and may be used to access features and options which are generically applicable, rather than being context or mode specific. State 970 may correspond to an extended menu, such as the extended menu 660 described above with reference to FIG. 6D. The specific features and options which are depicted as being available in state 970 are provided by way of example only, and are not intended to be limiting nor exhaustive.

Referring now to FIGS. 10A-10D, depicted are various additional screenshots taken from an electronic user device, such as the electronic user device 100 of FIG. 1, depicting additional content selection and navigation functionalities of a graphical user interface. In particular, the graphical user interface 1000 of FIG. 10A comprises a side bar 1010, which may have been accessed by pulling up a side bar tab (not shown). In any event, the side bar 1010 may include at least some context or mode specific icons that are user selectable so as to access various functions and/or options pertaining the current view/mode, which in this embodiment is the album view.

From the depicted mode, a plurality of media files may be accessed and selected, shown as selected media files 1020 in FIG. 10A. In certain embodiments, media files which have been user-selected (e.g., media files 1020) may be highlighted, as shown in FIG. 10A. Selected files can then be easily deleted or otherwise manipulated, using the options available from side bar 1010.

User-selected media files 1020 may also be organized, i.e., stacked, as shown in FIG. 10B. To that end, another aspect of the present disclosure is to introduce the concept of media file stacking, which exhibits the benefits of both a traditional folder system, but without the drawbacks of having to navigate through a potentially complex maze of folders and subfolders. In certain embodiments, the feature of stacking may be invoked by pressing and holding one of the media files 1030, below which the other selected media files 1020 will move under, as graphically represented in FIG. 10B. Thus, unlike a traditional folder structure, the stacking feature disclosed herein allows specifically selected files to be organized without ever having to leave the current level or view.

FIG. 10C shows how stacked media files 1040 may be arranged on the graphical user interface 1000. In this embodiments, the various media files contained either within the current view have been arranged into 9 different stacks. From this ‘stack’ view, a user may then select a particular stack 1050 to open. As graphically shown in FIG. 10D, after being opened the now-expanded stack 1050 is seen as the individual media files 1060 that previously comprised the particular stack 1050. Additionally, the other available stacks 1070 are simultaneously viewable, along with the expanded stack media files 1060. In this fashion, the stacking feature disclosed herein allows a user to navigate media content, which has been arranged and categorized by the user, without ever having to leave the current view (and hence not being able to navigate the other available media from within the same level).

It should be appreciated that the mode or view of the graphical user interface 1000 of FIGS. 10A-10D may correspond to either the play mode or the album mode, as described above with reference to FIG. 2.

Referring now to FIGS. 11A-11D, depicted are various additional screenshots taken from an electronic user device, such as the electronic user device 100 of FIG. 1, depicting additional content selection and navigation functionalities of a graphical user interface operating in the album view/mode described above with reference to FIG. 2. In particular, the graphical user interface 1100 of FIG. 11A comprises a side bar 1110, which may have been accessed by pulling up a side bar tab (not shown).

In any event, the graphical user interface 1100 is shown as containing a plurality of media files that have been arranged into a plurality of stacks 1020. In FIG. 11A, a user dragging motion 1130 is applied to the touch-sensitive screen in order to access an album mode 1140. As described above with reference to FIG. 2, albums may be user-defined collections of media file, organized or collected together according to type, date, event, location, etc. Such albums may each contain digital music files, digital still photos, digital video files, or any combination thereof.

Once in album mode 1140, as shown in FIG. 11B, previously defined albums 1150 may be readily accessed. Additionally, new albums may be readily created by selecting an icon to create a new album, as shown by user input 1160 in FIG. 11B.

FIG. 11C depicts on example of the graphical user interface 1100 after the user input 1160 has been provided to create a new album while in album mode. Specifically, a new album ribbon 1170 may be displayed above a graphical representation of the available media file stacks 1175, as shown in FIG. 11C. Upon selecting a stack, i.e., from selected stack 1180, the user may then be able to drag and drop one more of the media files from the selected stack 1180 onto the new album ribbon 1170. It should be appreciated that the selected stack 1180 may be first expanded, as described above, and then individual media files selected to be dragged to the new album ribbon 1170. Alternatively, the entire selected stack 1180 may be dragged to the new album ribbon 1170, and added thereto. Such icon selection, dragging and dropping operations may be performed by contacting the touch-sensitive display that is displaying the graphical user interface 1100, as has been described above.

Finally, FIG. 11D depicts the graphical user interface 1100 after a plurality of individual media files 1185 from the selected stack 1180 have been added to the new album ribbon. The user may then readily navigate the various media files added to the new album by navigating in direction 1190, again using the device's touch-sensitive screen.

While various examples have been described herein with respect to specific submenus and icons, it should be appreciated that such examples are provided by way of illustration only and are not intended to limit the scope of the invention. This application is intended to cover any variations, uses or adaptation of the invention following, in general, the principles of the invention, and including such departures from the present disclosure as come within the known and customary practice within the art to which the invention pertains.

What is claimed is:

1. A method for navigating a graphical user interface, displayed on a touchscreen display of an electronic user device, using multi-dimensional menus and modes, the method comprising the acts of:
arranging a plurality of operating modes along at least a two dimensional plane of the graphical user interface, wherein the plurality of operating modes comprises at least a media play mode and a media capture mode;
displaying, on the touchscreen display of the electronic user device, a currently-active view of a first one of the plurality of operating modes;
receiving a user input, to the touchscreen display of the electronic user device, to change the currently-active view from the first one of the plurality of operating modes to a second one of the plurality of operating modes;
navigating, in response to the user input, in a desired direction of the at least two dimensional plane of the graphical user interface, corresponding to the second one of the plurality of operating modes; and
displaying, as the currently-active view on the touchscreen display of the electronic user device following said navigating, a graphical representation of the second one of the plurality of operating modes.

2. The method of claim 1, wherein the user input comprises a user contact of the touchscreen, followed by a user motion during the user contact, which is graphically represented as a dragging effect on the graphical user interface.

3. The method of claim 1, wherein arranging the plurality of operating modes further comprises arranging the plurality of operating modes along a three dimensional plane of the graphical user interface.

4. The method of claim 3, wherein the media play mode and the media capture mode are accessible along first and second dimensions of the three dimensional plane of the graphical user interface.

5. The method of claim 4, wherein the plurality of operating modes further comprises a zoom mode accessible along a third dimension of the three dimensional plane of the graphical user interface.

6. The method of claim 1, further comprising displaying a side bar on the graphical user interface in response to an additional user contact and predetermined user motion during such additional user contact.

7. The method of claim 6, wherein the side bar comprising a plurality of user-selectable icons at least one of which corresponds to the currently-active view, and wherein the plurality of user-selectable icons are selectable to access at least one of device function, additional menu level and device option.

8. The method of claim 7, further comprising displaying an expanded menu on the graphical user interface, wherein the expanded menu is accessible only after displaying the side bar, and wherein the expanded menu comprising an additional plurality of user-selectable icons that do not only correspond to the currently-active view.

9. The method of claim 1, wherein the plurality of operating modes further comprises an album mode for accessing a plurality of stored media files that have been graphically organized into one or more albums.

10. The method of claim 1, wherein the media play mode enables stored media files to be accessed, and wherein the media capture mode enables digital video and photos to be captured.

11. The method of claim 1, further comprising:
organizing a plurality of media files, stored on the electronic user device, into one or more groupings; and
graphically representing the one or more groupings on the graphical user interface as one or more corresponding stacks.

12. The method of claim 11, further comprising expanding and collapsing the plurality of media files out of and into the one or more stacks, respectively, in response to corresponding user inputs and without changing from a current level in which the plurality of media files are stored.

13. The method of claim 1, wherein displaying the graphical representation of the second one of the plurality of operating modes further comprises graphically performing a mode transition from the first one of the plurality of operating modes to the second one of the plurality of operating modes, wherein the mode transition is graphically represented as one of a progressing transition line or graphical symbol.

14. The method of claim 13, further comprising transitioning, during said mode transition, a current functionality associated with at least a first icon within a side bar of the graphical user interface to a new functionality, wherein the current functionality corresponds to the first one of the plurality of operating modes and wherein the new functionality corresponds to the second one of the plurality of operating modes.

15. The method of claim 14, further comprising graphically transitioning, during said mode transition, the at least first icon within the side bar of the graphical user interface to a corresponding at least second icon within the side bar, wherein the at least first icon corresponds to the first one of the plurality of operating modes and wherein the at least second icon corresponds to the second one of the plurality of operating modes.

16. An electronic user device comprising:
a touchscreen display;
a memory containing processor-executable instructions for navigating a graphical user interface, displayed on the touchscreen display, using multi-dimensional menus and modes; and
a processor electrically coupled to the memory and the touchscreen display, the processor configured to execute the processor-executable instructions to:
provide a plurality of operating modes along at least a two dimensional plane of the graphical user interface, wherein the plurality of operating modes comprises at least a media play mode and a media capture mode,
display, on the touchscreen display, a currently-active view of a first one of the plurality of operating modes,
receive a user input, to the touchscreen display, to change the currently-active view from the first one of the plurality of operating modes to a second one of the plurality of operating modes,
navigate, in response to the user input, in a desired direction of the at least two dimensional plane of the graphical user interface user interface, corresponding to the second one of the plurality of operating modes, and
display, as the currently-active view on the touchscreen display following said navigating, a graphical representation of the second one of the plurality of operating modes.

17. The electronic user device of claim 16, wherein the user input comprises a user contact of the touchscreen, followed by a user motion during the user contact, which is graphically represented as a dragging effect on the graphical user interface.

18. The electronic user device of claim 16, wherein the processor is configured to provide the plurality of operating modes by providing the plurality of operating modes along a three dimensional plane of the graphical user interface.

19. The electronic user device of claim 18, wherein the media play mode and the media capture mode are accessible along first and second dimensions of the three dimensional plane of the graphical user interface.

20. The electronic user device of claim 19, wherein the plurality of operating modes further comprises a zoom mode accessible along a third dimension of the three dimensional plane of the graphical user interface.

21. The electronic user device of claim 16, wherein the processor is further configured to execute the processor-executable instructions to display a side bar on the graphical user interface in response to an additional user contact and predetermined user motion during such additional user contact.

22. The electronic user device of claim 21, wherein the side bar comprising a plurality of user-selectable icons at least one of which corresponds to the currently-active view, and wherein the plurality of user-selectable icons are selectable to access at least one of device function, additional menu level and device option.

23. The electronic user device of claim 22, wherein the processor is further configured to execute the processor-executable instructions to display an expanded menu on the graphical user interface, wherein the expanded menu is accessible only after displaying the side bar, and wherein the expanded menu comprising an additional plurality of user-selectable icons that do not only correspond to the currently-active view.

24. The electronic user device of claim 16, wherein the plurality of operating modes further comprises an album mode for accessing a plurality of stored media files that have been graphically organized into one or more albums.

25. The electronic user device of claim 16, wherein the media play mode enables stored media files to be accessed, and wherein the media capture mode enables digital video and photos to be captured.

26. The electronic user device of claim 16, wherein the processor is further configured to execute the processor-executable instructions to:
organize a plurality of media files, stored on the electronic user device, into one or more groupings, and
graphically represent the one or more groupings on the graphical user interface as one or more corresponding stacks.

27. The electronic user device of claim 26, wherein the processor is further configured to execute the processor-executable instructions to expand and collapse the plurality of media files out of and into the one or more stacks, respectively, in response to corresponding user inputs and without changing from a current level in which the plurality of media files are stored.

28. The electronic user device of claim 16, wherein the processor is further configured to display the graphical representation of the second one of the plurality of operating modes by graphically performing a mode transition from the first one of the plurality of operating modes to the second one of the plurality of operating modes, wherein the mode transition is graphically represented as one of a progressing transition line or graphical symbol.

29. The electronic user device of claim 28, wherein the processor is further configured to execute the processor-executable instructions to transition, during said mode transition, a current functionality associated with at least a first icon within a side bar of the graphical user interface to a new functionality, wherein the current functionality corresponds to the first one of the plurality of operating modes and wherein the new functionality corresponds to the second one of the plurality of operating modes.

30. The electronic user device of claim 29, wherein the processor is further configured to execute the processor-executable instructions to graphically transition, during said mode transition, the at least first icon within the side bar of the graphical user interface to a corresponding at least second icon within the side bar, wherein the at least first icon corresponds to the first one of the plurality of operating modes and wherein the at least second icon corresponds to the second one of the plurality of operating modes.

31. A graphical user interface of an electronic user device with a touchscreen display, wherein the graphical user interface comprises:
a plurality of operating modes arranged along at least a two dimensional plane of the graphical user interface, wherein the plurality of operating modes comprises at least a media play mode and a media capture mode;
a currently-active view of a first one of the plurality of operating modes displayed on the touchscreen display of the electronic user device, wherein the currently-active view is changeable from the first one of the plurality of operating modes to a second one of the plurality of operating modes in response to a user input; and
a graphical representation of the second one of the plurality of operating modes which is displayed on the touchscreen display as the currently-active view following the user input, wherein the user input corresponds to an instruction to navigate in a direction of the at least two dimensional plane of the graphical user interface which corresponds to the second one of the plurality of operating modes.

32. The graphical user interface of claim 31, wherein the user input comprises a user contact of the touchscreen, followed by a user motion during the user contact, which is graphically represented as a dragging effect on the graphical user interface.

33. The graphical user interface of claim 31, wherein the plurality of operating modes are arranged along a three dimensional plane of the graphical user interface.

34. The graphical user interface of claim 33, wherein the media play mode and the media capture mode are accessible along first and second dimensions of the three dimensional plane of the graphical user interface.

35. The graphical user interface of claim 34, wherein the plurality of operating modes further comprises a zoom mode accessible along a third dimension of the three dimensional plane of the graphical user interface.

36. The graphical user interface of claim 31, further comprising a side bar that is displayed in response to an additional user contact and predetermined user motion during such additional user contact.

37. The graphical user interface of claim 36, wherein the side bar comprising a plurality of user-selectable at least one of which corresponds to the currently-active view, and wherein the plurality of user-selectable icons are selectable to access at least one of device function, additional menu level and device option.

38. The graphical user interface of claim 37, further comprising an expanded menu that is displayed only after displaying the side bar, and wherein the expanded menu comprising an additional plurality of user-selectable icons that do not only correspond to the currently-active view.

39. The graphical user interface of claim 31, wherein the plurality of operating modes further comprises an album mode for accessing a plurality of stored media files that have been graphically organized into one or more albums.

40. The graphical user interface of claim 31, wherein the media play mode enables stored media files to be accessed, and wherein the media capture mode enables digital video and photos to be captured.

41. The graphical user interface of claim 31, further comprising a graphical representation of a plurality of media files, stored on the electronic user device, which have been organized into one or more groupings, wherein the graphical representation depicts the one or more groupings as one or more corresponding stacks.

42. The graphical user interface of claim 41, wherein the plurality of media files are expandable and collapsible out of and into the one or more stacks, respectively, in response to corresponding user inputs and without changing from a current level in which the plurality of media files are stored.

43. The graphical user interface of claim 31, wherein the graphical representation of the second one of the plurality of operating modes further comprises a graphical representation of a mode transition from the first one of the plurality of operating modes to the second one of the plurality of operating modes, wherein the mode transition is graphically represented as one of a progressing transition line or graphical symbol.

44. The graphical user interface of claim 43, wherein, during said mode transition, a current functionality associated with at least a first icon within a side bar of the graphical user interface is to a new functionality, wherein the current functionality corresponds to the first one of the plurality of operating modes and wherein the new functionality corresponds to the second one of the plurality of operating modes.

45. The graphical user interface of claim 44, further comprising a graphical representation, displayed during said mode transition, the at least first icon within the side bar of the graphical user interface to a corresponding at least second icon within the side bar, wherein the at least first icon corresponds to the first one of the plurality of operating modes and wherein the at least second icon correspond to the second one of the plurality of operating modes.
